(19) United States
(12) Patent Application Publication
(10) Pub. No.: US 2025/0042293 A1
(43) Pub. Date: Feb. 6, 2025

(54) Local Dynamic Load Balancing for EV Charging with Power Line Communication

(71) Applicant: Computime Limited, Hong Kong (HK)

(72) Inventors: Kam Tim Cheung, Hong Kong (HK); Leung Yin Chan, Hong Kong (HK); Pui Keung Tam, Hong Kong (HK)

(21) Appl. No.: 18/491,281

(22) Filed: Oct. 20, 2023

Related U.S. Application Data
(60) Provisional application No. 63/516,539, filed on Jul. 31, 2023.

(51) Int. Cl. B60L 53/67; B60L 53/63; H04B 3/54; H04L 12/40

(52) U.S. Cl. CPC B60L 53/67; B60L 53/63; H04B 3/544; H04L 12/40045; H04L 12/40032; H04L 2012/40273

(57) ABSTRACT

A power line communication device measures a total current flowing through one or more power lines providing power to EV chargers. The device establishes communication with at least one of the EV chargers using the one or more power lines as the communications medium. The device further communicates power management information to the EV chargers. When the device receives a request from the EV chargers, it calculates a current for each of the EV chargers from the total current, the preset maximum current, or both the total current and the preset maximum current, and communicates a calculated current to each of the EV chargers. Alternatively, the device can provide the total current to one of the EV chargers that acts as a power manager and communicates power management information to the other EV chargers using the one or more power lines as the communications medium.

### RELATED APPLICATIONS

This application claims the benefit of U.S. Provisional Patent Application Ser. No. 63/516,539, filed on Jul. 31, 2023, the content of which is incorporated by reference herein in its entirety.

### FIELD OF THE INVENTION

This invention relates to load balancing for electric vehicle (EV) charging with power line communication.

### BACKGROUND

Installing EV chargers in a parking lot or a parking garage takes a large-scale effort. It requires not only connecting the power lines but also setting up the communication between the EV chargers and the cloud.

For wireline communication, ethernet cables or RS485 cables are usually installed to connect the EV chargers to the cloud via a gateway. For wireless communication, a WiFi (IEEE 802.11) or cellular network is usually installed to connect the EV chargers to the cloud. Both methods require electronics engineers in order to install and set up the EV chargers. This lengthens the installation time and increases the installation cost.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram showing a static load balancing method in a fully occupied parking lot.

FIG. 3 is an exemplary diagram showing a static load balancing method in a partially occupied parking lot.

FIG. 4 is an exemplary diagram showing a dynamic load balancing method with WiFi communication when there are two charging cars.

FIG. 5 is an exemplary diagram showing a dynamic load balancing method with WiFi communication when there are four charging cars

FIG. 6 is an exemplary diagram showing a dynamic load balancing method with WiFi communication when there are three charging cars.

FIG. 7 is an exemplary diagram showing a dynamic load balancing method with power line communication when there are two charging cars, in accordance with various embodiments.

FIG. 8 is an exemplary diagram showing a dynamic load balancing method with power line communication when there are four charging cars, in accordance with various embodiments.

FIG. 9 is an exemplary diagram showing a dynamic load balancing method with power line communication when there are three charging cars, in accordance with various embodiments.

FIG. 10 is a flowchart showing a method for communicating the real-time current available to EV chargers, in accordance with various embodiments.

FIG. 11 is a schematic diagram of a system that includes one or more distinct software modules and that performs a method for communicating the real-time current available to EV chargers, in accordance with various embodiments

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF EMBODIMENTS

### Computer-Implemented System

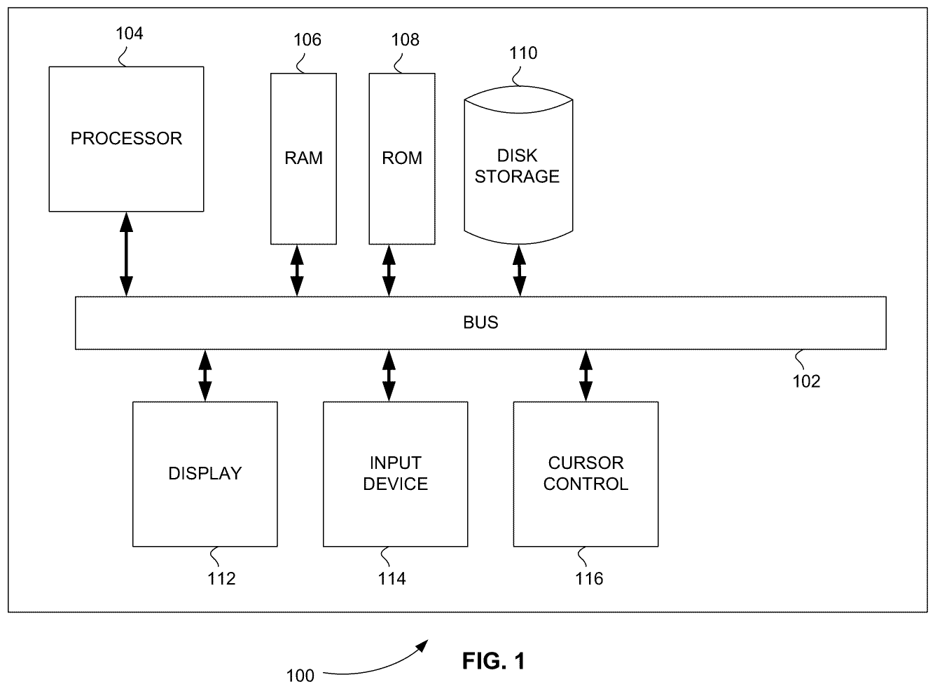

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed—to allow for performance and decreased cost. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media and volatile media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

Local Dynamic Load Balancing for Ev Charging with Power Line Communication

As described above, installing EV chargers in a parking lot or a parking garage takes a large-scale effort. It requires not only connecting the power lines but also setting up the communication between the EV chargers and the cloud.

Each building or charging location has a different and limited amount of electrical power for EV charging. Each building or charging location can also have a different number of EV chargers. In the following non-limiting example, there are five EV chargers installed in a parking lot, the maximum capacity of the power assigned to these EV chargers is 100 amperes (A).

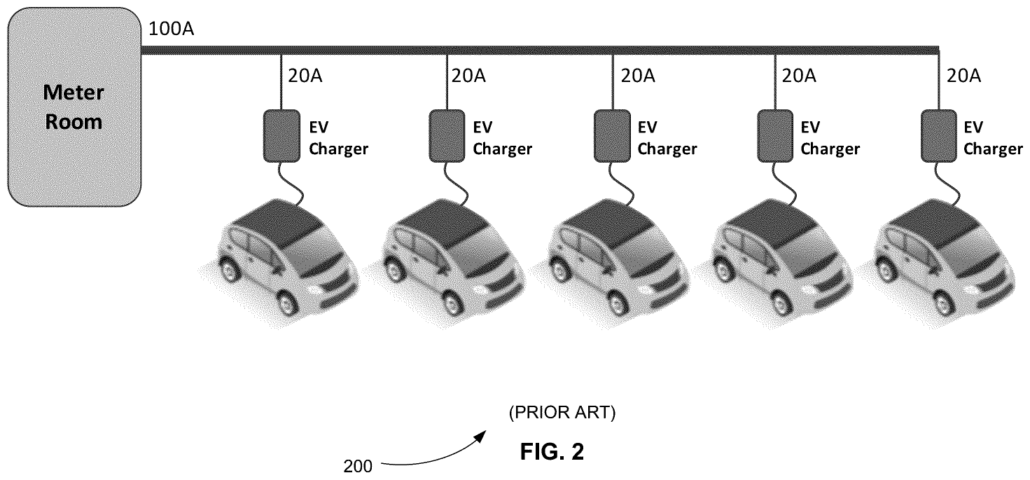

FIG. 2 is an exemplary diagram 200 showing a static load balancing method in a fully occupied parking lot. Each EV charger receives the same and fixed amount of electricity, 20 A, which is supplied to each EV charger. When there are five charging cars, each charging car is allocated with 20 A, with the available power evenly distributed.

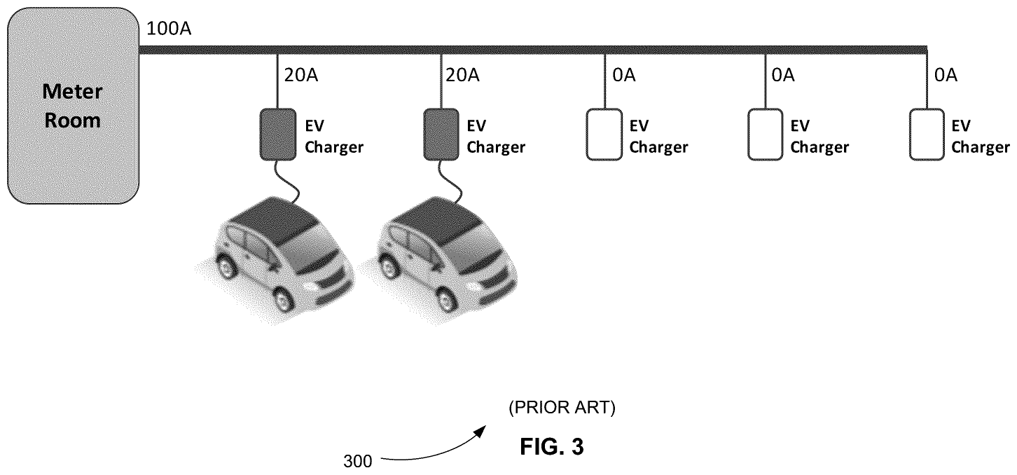

FIG. 3 is an exemplary diagram 300 showing a static load balancing method in a partially occupied parking lot. Each EV charger receives the same and fixed amount of electricity. For example, 20 A is supplied to each EV charger. When there are two charging cars, three EV chargers are left idle. Each charging car is allocated with 20 A and 60 A is left unused. Thus, the available power is not optimally distributed.

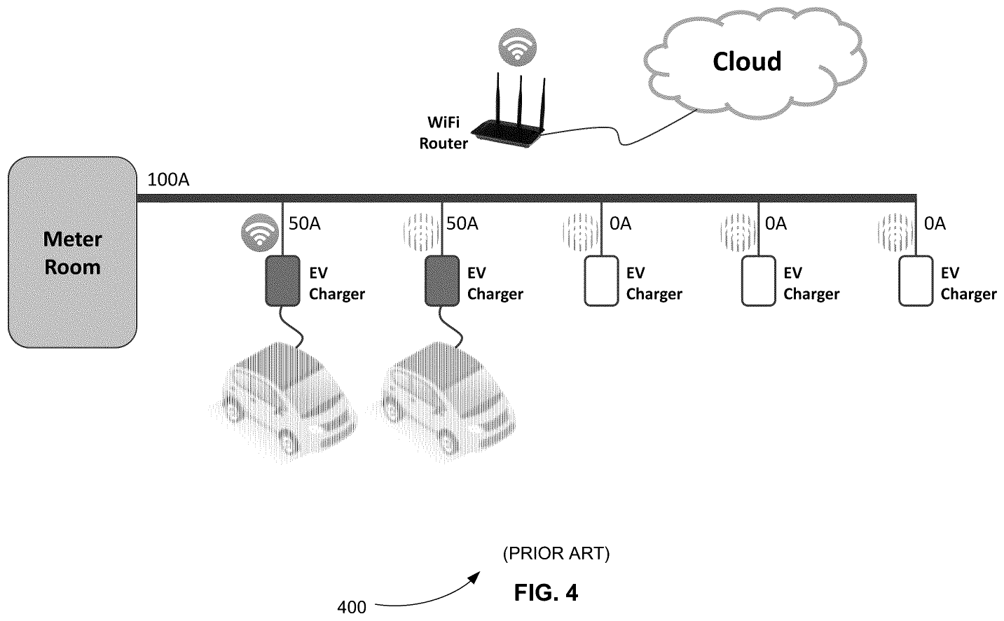

FIG. 4 is an exemplary diagram 400 showing a dynamic load balancing method with WiFi communication when there are two charging cars. The EV chargers that possess a WiFi communication capability can connect to a WiFi network easily with a WiFi router. All EV chargers are communicating to the cloud or computer servers with the WiFi communication network. If, alternatively, the EV chargers possess cellular communication capability, they can be connected to the cloud directly without a router. A central management system in the cloud communicates with all the EV chargers and is notified that there are two charging cars and three idle EV chargers. Then, the central management system issues a message to the two EV chargers with charging cars. The maximum assigned current is 100 A. This current is dynamically allocated to the two charging cars, with each charging car being allocated 50 A. The available power is then optimally distributed.

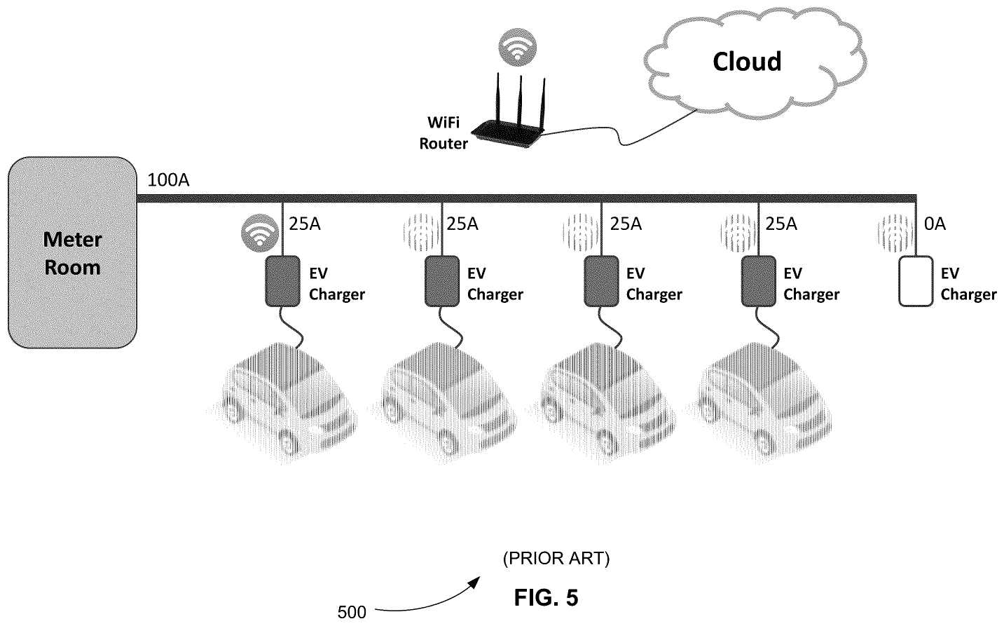

FIG. 5 is an exemplary diagram 500 showing a dynamic load balancing method with WiFi communication when there are four charging cars. When two cars are being charged and two more cars arrive, the associated EV chargers notify the central management system in the cloud. Then, the central management system issues a message to the four EV chargers with charging cars. The four charging cars are then allocated with 25 A individually.

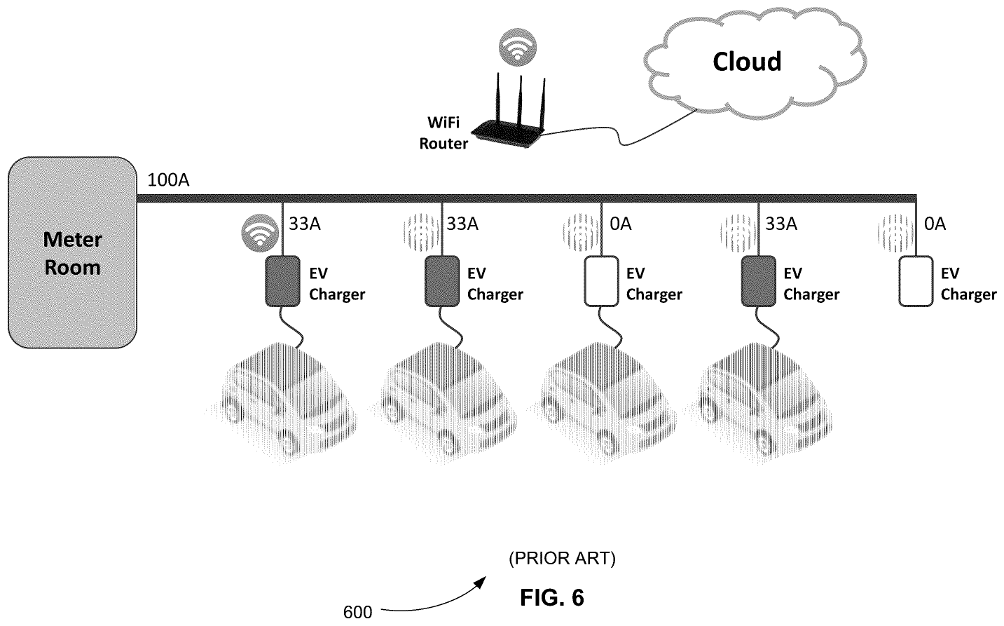

FIG. 6 is an exemplary diagram 600 showing a dynamic load balancing method with WiFi communication when there are three charging cars. When a car is completely charged, the associated EV charger notifies the central management system in the cloud. Then, the central management system issues a message to the three EV chargers with the remaining charging cars. Then, 33 A is dynamically allocated to the remaining three charging cars. The disadvantage of this method is that if the Internet or the cloud goes down, there will be no dynamic load balancing.

In various embodiments, dynamic load balancing is provided using power line communication. Power line communication uses the power lines as the medium for sending and retrieving information. There is no need to lay new lines of communication. It requires only installing the power lines by certified electricians. It reduces the installation time and reduces the installation cost while providing reliable and robust networking. The EV chargers that possess power line communication capability connect to the power line communication network as easily as they connect to the power of the power lines.

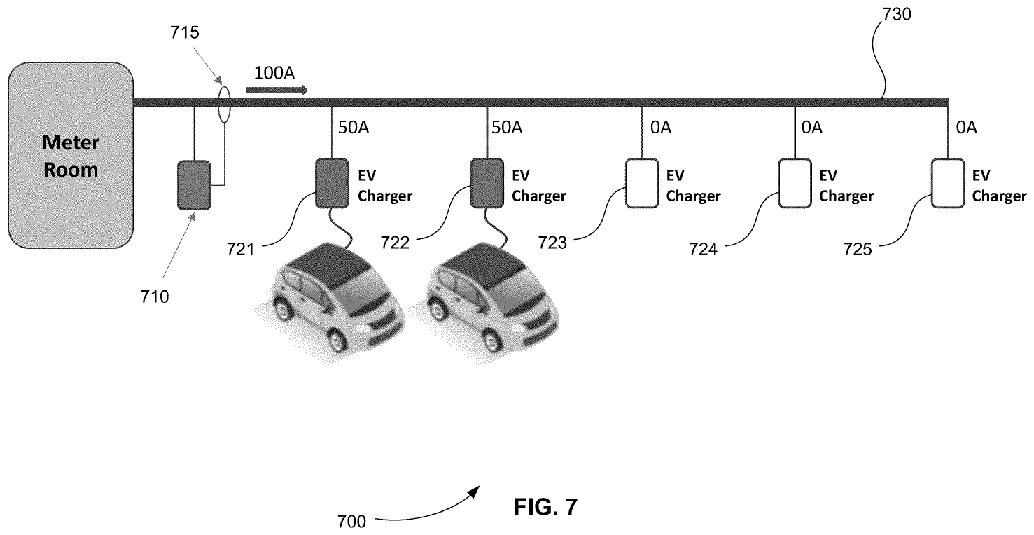

FIG. 7 is an exemplary diagram 700 showing a dynamic load balancing method with power line communication when there are two charging cars, in accordance with various embodiments. Power line communication module or device 710 measures the real-time total current flowing from the grid to the EV chargers 721-725, using, for example, a current transformer meter 715. The maximum total current that can be supplied to EV chargers 721-725 connected to the power lines is pre-set in the power line communication device. Power line communication device 710 acts as a power manager that can intelligently allocate the available power based on the real-time needs of vehicles. This method supports more EVs and allocates power dynamically to each EV in the most efficient way without connecting to the cloud. Power line communication device 710 can include a processor, controller, or computer system, such as the computer system of FIG. 1.

EV chargers 721-725 are communicating with power line communication device 710 over power line 730. Power line communication device 710 is notified that there are two charging cars and three idle EV chargers 723-725. Then, power line communication device 710 issues a message to EV chargers 721-722 with charging cars. The maximum assigned current is 100 A, the two charging cars are allocated with 50 A individually. The available power is optimally distributed.

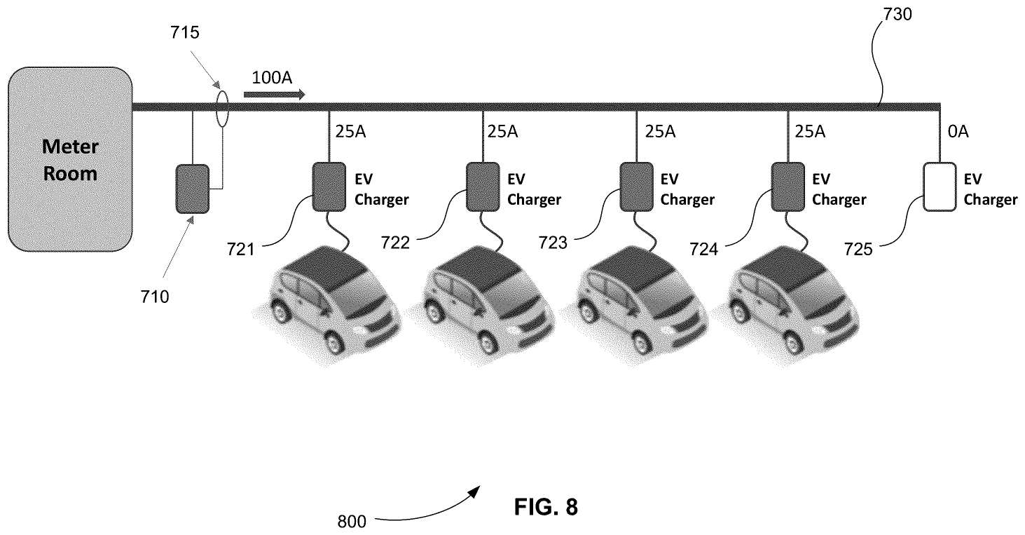

FIG. 8 is an exemplary diagram showing a dynamic load balancing method with power line communication when there are four charging cars, in accordance with various embodiments. When two cars are being charged, two more cars arrive and the associated EV chargers 723-724 notify power line communication device 710. Then, power line communication device 710 issues a message to the four EV chargers 721-724 with charging cars. The four charging cars are allocated with 25 A individually. In other words, the message instructs EV chargers 721-722 to decrease their current draw from 50 A to 25 A and instructs EV chargers 723-724 to increase their current from 0 A to 25 A.

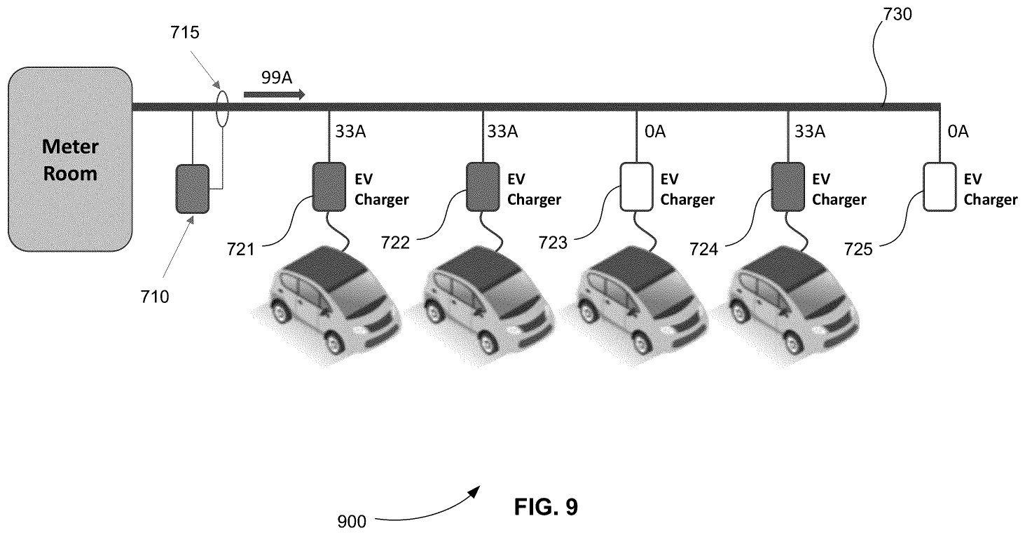

FIG. 9 is an exemplary diagram showing a dynamic load balancing method with power line communication when there are three charging cars, in accordance with various embodiments. When a car is completely charged, the associated EV charger 723 notifies power line communication device 710. Then, power line communication device 710 issues a message to the three EV chargers 721, 722, and 724 with charging cars, providing 33 A is to be dynamically allocated to the remaining three charging cars. In other words, the message instructs EV chargers 721, 722, and 724 to increase their current draw from 25 A to 33 A.

In the examples, the allocation of power is based on an evenly distributed principle. In various embodiments, it can be based on the first-in first-charged principle, a phase aware algorithm, or any algorithm. The advantage of this local dynamic load balancing for EV charging with power line communication is that it reduces the installation time and cost. It also in real-time allocates the available power to the charging cars without connecting to the cloud.

In an alternative embodiment, one of the EV chargers is assigned to be the power manager, and the power line communication device only provides the maximum current of the power lines and the real-time total current flowing to the EV chargers or the EV charger that is the power manager. An EV charger can include a processor, controller, or computer system, such as the computer system of FIG. 1.

### System for Communicating the Real-Time Current Available to EV Chargers

Returning to FIG. 7, a system for communicating the real-time current available to EV chargers is shown. This system includes power line communication device 710. Power line communication device 710 measures a total current flowing through one or more power lines providing power to m EV chargers 721-725. Power line communication device 710 establishes communications with one or more of m EV chargers 721-725 using one or more power lines 730 as the communications medium. In various embodiments, power line communication device 710 further includes a preset maximum current for one or more power lines 730.

In various embodiments, power line communication device 710 further provides dynamic load balancing. For example, power line communication device 710 establishes communication with at least each of n chargers 721-722 of the m EV chargers 721-725, where n≤m. Power line communication device 710 further receives a request for power from n chargers 721-722. In other words, n chargers 721-722 are telling power line communication device 710 that they have cars to charge. Power line communication device 710 calculates a current for each of the n chargers from the total current, the preset maximum current, or both the total current and the preset maximum current. Finally, power line communication device 710 communicates a calculated current to each of n chargers 721-722.

In various embodiments, power line communication device 710 calculates a current for each of n chargers 721-722 based on a first-in, first-charged principle.

In various embodiments, power line communication device 710 calculates a current for each of n chargers 721-722 based on a phase aware algorithm.

In various embodiments, power line communication device 710 calculates a current for each of n chargers 721-722 by evenly dividing the total current among n chargers 721-722.

In various embodiments, a power managing EV charger provides dynamic load balancing. For example, the power managing EV charger is EV Charger 721 of m EV chargers 721-725. Power line communication device 710 communicates the total current, the preset maximum current, or both the total current and the preset maximum current to power managing EV charger 721. Power managing EV charger 721 establishes communications with at least each of n chargers 722 of the m−1 chargers 722-725, where n≤m−1, using one or more power lines 730 as the communications medium. Power managing EV charger 721 further receives a request for power from n chargers 722. Power managing EV charger 721 calculates a current for each of n chargers 722 and power managing EV charger 721 from the total current, the preset maximum current, or both the total current and the preset maximum current. In this case, since EV chargers 721 and 722 both have cars requesting charging, a current is calculated for both chargers. Power managing EV charger 721 communicates a calculated current to each of n chargers 722. In this case, power managing EV charger 721 calculates a current for itself but does not need to communicate it across one or more power lines 730.

Similarly, as above, in various embodiments, power managing EV charger 721 calculates a current for each of n chargers 722 and power managing EV charger 721 based on a first-in, first-charged principle.

In various embodiments, power managing EV charger 721 calculates a current for each of n chargers 722 and power managing EV charger 721 based on a phase aware algorithm.

In various embodiments, power managing EV charger 721 calculates a current for each of n chargers 722 and power managing EV charger 721 by evenly dividing the total current among n chargers 721-722.

### Method for Communicating the Real-Time Current Available to EV Chargers

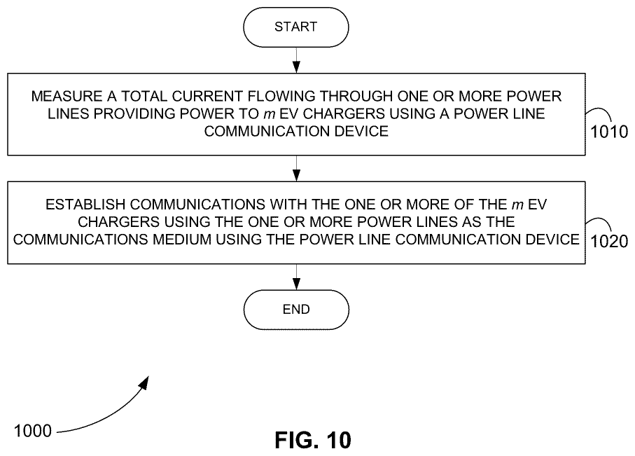

FIG. 10 is a flowchart showing a method 1000 for communicating the real-time current available to EV chargers, in accordance with various embodiments.

In step 1010 of method 1000, a total current flowing through one or more power lines providing power to m EV chargers is measured using a power line communication device.

In step 1020, communications are established with the one or more of the m EV chargers using the one or more power lines as the communications medium using the power line communication device.

### Computer Program Product for Communicating the Real-Time Current Available

In various embodiments, a computer program product includes a non-transitory tangible computer-readable storage medium whose contents include a program with instructions being executed on a processor so as to perform a method for communicating the real-time current available to EV chargers. The processor can be, but is not limited to, a controller, a computer, a microprocessor, the computer system of FIG. 1, or any device capable of providing control signals and analyzing data. This method is performed by a system that includes one or more distinct software modules.

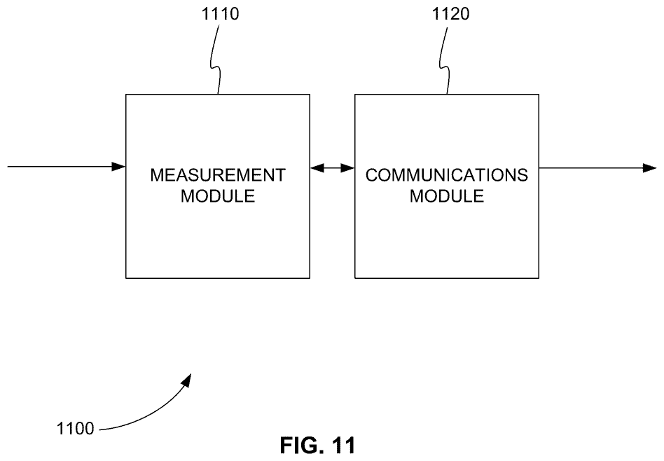

FIG. 11 is a schematic diagram of a system 1100 that includes one or more distinct software modules and that performs a method for communicating the real-time current available to EV chargers, in accordance with various embodiments. System 1100 includes measurement module 1110 and communications module 1120.

Measurement module 1110 measures a total current flowing through one or more power lines providing power to m EV chargers. Communications module 1120 establishes communications with the one or more of the m EV chargers using the one or more power lines as the communications medium.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for communicating the real-time current available to electric vehicle (EV) chargers, comprising:
a power line communication device that
measures a total current flowing through one or more power lines providing power to m EV chargers and
establishes communications with the one or more of the m EV chargers using the one or more power lines as the communications medium.

2. The system of claim 1, wherein the power line communication device further includes a preset maximum current for the one or more power lines.

3. The system of claim 2, wherein
the power line communication device establishes communication with each of n chargers of the m EV chargers, where n≤m,
the power line communication device further receives a request for power from the n chargers,
the power line communication device calculates a current for each of the n chargers from the total current, the preset maximum current, or both the total current and the preset maximum current, and
the power line communication device communicates a calculated current to each of the n chargers.

4. The system of claim 3, wherein the power line communication device calculates a current for each of the n chargers based on a first-in, first-charged principle.

5. The system of claim 3, wherein the power line communication device calculates a current for each of the n chargers based on a phase aware algorithm.

6. The system of claim 3, wherein the power line communication device calculates a current for each of the n chargers by evenly dividing the total current among the n chargers.

7. The system of claim 2, further comprising a power managing EV charger, wherein
the power managing EV charger is one of the m EV chargers,
the power line communication device communicates the total current, the preset maximum current, or both the total current and the preset maximum current to the power managing EV charger,
the power managing EV charger establishes communications with each of n chargers of the m−1 chargers, where n≤; m−1, using the one or more power lines as the communications medium,
the power managing EV charger further receives a request for power from the n chargers,
the power managing EV charger calculates a current for each of the n chargers and the power managing EV charger from the total current, the preset maximum current, or both the total current and the preset maximum current, and
the power managing EV charger communicates a calculated current to each of the n chargers.

8. The system of claim 7, wherein the power managing EV charger calculates a current for each of the n chargers based on a first-in, first-charged principle.

9. The system of claim 7, wherein the power managing EV charger calculates a current for each of the n chargers based on a phase aware algorithm.

10. The system of claim 7, wherein the power managing EV charger calculates a current for each of the n chargers by evenly dividing the total current among the n chargers.

11. A method for communicating the real-time current available to electric vehicle (EV) chargers, comprising:
measuring a total current flowing through one or more power lines providing power to m EV chargers using a power line communication device and
establishing communications with the one or more of the m EV chargers using the one or more power lines as the communications medium using the power line communication device.

12. The method of claim 11, wherein
the power line communication device establishes communication with each of n chargers of the m EV chargers, where n≤m,
the power line communication device further receives a request for power from the n chargers,
the power line communication device calculates a current for each of the n chargers from the total current, the preset maximum current, or both the total current and the preset maximum current, and
the power line communication device communicates a calculated current to each of the n chargers.

13. The method of claim 12, wherein the power line communication device calculates a current for each of the n chargers based on a first-in, first-charged principle.

14. The method of claim 12, wherein the power line communication device calculates a current for each of the n chargers based on a phase aware algorithm.

15. The method of claim 12, wherein the power line communication device calculates a current for each of the n chargers by evenly dividing the total current among the n chargers.

16. The method of claim 11, wherein
the m EV chargers include a power managing EV charger,
the power line communication device communicates the total current, a preset maximum current, or both the total current and the preset maximum current to the power managing EV charger,
the power managing EV charger establishes communications with each of n chargers of the m−1 EV chargers, where n≤m−1, using the one or more power lines as the communications medium,
the power managing EV charger further receives a request for power from the n chargers,
the power managing EV charger calculates a current for each of the n chargers and the power managing EV charger from the total current, the preset maximum current, or both the total current and the preset maximum current, and
the power managing EV charger communicates a calculated current to each of the n chargers.

17. The method of claim 16, wherein the power managing EV charger calculates a current for each of the n chargers based on a first-in, first-charged principle.

18. The method of claim 16, wherein the power managing EV charger calculates a current for each of the n chargers based on a phase aware algorithm.

19. The method of claim 16, wherein the power managing EV charger calculates a current for each of the n chargers by evenly dividing the total current among the n chargers.

20. A computer program product, comprising a non-transitory tangible computer-readable storage medium whose contents cause a processor to perform a method for communicating the real-time current available to electric vehicle (EV) chargers, comprising:
providing a system, wherein the system comprises one or more distinct software modules, and wherein the distinct software modules comprise a measurement module and a communications module;
measuring a total current flowing through one or more power lines providing power to m EV chargers using the measurement module; and
establishing communications with the one or more of the m EV chargers using the one or more power lines as the communications medium using the communications module.
